(19) United States
(12) Patent Application Publication
(10) Pub. No.: US 2007/0199797 A1
(43) Pub. Date: Aug. 30, 2007

(54) Molded parts with fabric surface areas and processes for their production

(75) Inventors: Steven Alan Sell, Midland, MI (US); Brent Alan Salamon, Midland, MI (US); Michael Hus, Midland, MI (US); Kin Fung Alex Yeung, Hong Kong (CN); Joseph Langmaid, Caro, MI (US)

Correspondence Address: DOBRUSIN & THENNISCH PC, 29 W LAWRENCE ST, SUITE 210, PONTIAC, MI, 48342, US

(73) Assignee: Dow Global Technologies Inc.

(21) Appl. No.: 11/361,787

(22) Filed: Feb. 24, 2006

(51) Int. Cl. B66B 23/22

(52) U.S. Cl. 198/335

(57) ABSTRACT

The present invention provides a fabric-laminated plastic part and a novel process of locating the fabric upon a plastic substrate component where the fabric extends over a contour of the plastic substrate component.

This invention relates to molded plastic parts having a fabric surface area and a process for making these parts particularly where a portion of the fabric extends over a contour of the part such as a corner of the part. Such parts can be produced with desirable appearance, small dimensional tolerances, thin part cross sections, desirable part shapes and configurations, combinations there or the like.

### BACKGROUND OF THE INVENTION

For many years, industry has been forming parts for various articles of manufacture by attaching fabrics to plastic substrates. Such fabrics can provide desirable attributes to these parts such as a desirable aesthetic appearance, desirable contact surfaces (e.g., for gripping or general feel), relatively simple design variability (e.g., through the use of different fabrics), combinations thereof or the like.

More recently, industry has begun forming such parts by molding (e.g., insert injection molding) the plastic substrates such that the fabrics are disposed thereon. However, location of fabrics upon these plastic substrates during such molding processes can present multiple difficulties. As one example, the molding processes that locate the fabrics upon the plastic substrates can be relatively costly. As another example, it can be difficult for the fabrics to extend over contours of the plastic substrates during molding. As another example, it can be difficult to locate the fabric relative to the substrates with consistency and accuracy using a molding process. As yet another example, it can be difficult to provide for a molding technique that results in a robust attachment of the fabrics to the plastic substrates. Thus, the present invention provides a molding process and a molded part or article that address one or any combination of the aforementioned difficulties or other difficulties as will become clear from a reading of the detailed description.

### SUMMARY OF THE INVENTION

A process of forming a molded plastic article is disclosed. According to the process, a surface fabric piece is provided. The fabric piece if formed of a fabric, a backing or both. The fabric piece preferably has a predetermined shape that includes a first portion disposed at an angle relative to a second portion wherein the first portion is interconnected with the second portion by an intermediate contour. The fabric piece, once formed, is typically located between portions of a mold such that the intermediate contour of the fabric piece, before or after closure of the mold, nests within an angled portion of the mold. For assisting in such nesting, the angled portion typically has a size and shape corresponding to the intermediate contour of the fabric. A plastic material is fed into the mold for forming a plastic substrate component attached to the fabric piece thereby forming the molded plastic article. The plastic substrate component can include a first surface and a second surface interconnected by an intermediate contour of the plastic substrate component. In such an embodiment, the fabric piece typically overlays the first surface and second surface of the plastic substrate component and the fabric piece extends over the intermediate contour of the plastic substrate component such that the intermediate contour of the fabric piece overlays the intermediate contour of the plastic substrate component. Once formed, the article may be removed from the mold and used for an article of manufacture.

### BRIEF DESCRIPTION OF THE DRAWINGS

FIG. 1 is a sectional view of an exemplary edge of an article in accordance with an aspect of the present invention.

FIG. 2 is a sectional view of another exemplary edge of an article in accordance with an aspect of the present invention.

FIG. 3 is a schematic of an article being formed by an exemplary process in accordance with an aspect of the present invention.

FIG. 4 is a sectional view of another exemplary edge of an article in accordance with an aspect of the present invention.

FIG. 4A is a sectional view of another exemplary edge of an article in accordance with an aspect of the present invention.

FIGS. 5 and 6 are sectional views of an exemplary mold forming an exemplary article in accordance with an aspect of the present invention.

FIG. 7 is sectional view of an exemplary molded article according to an aspect of the present invention.

FIG. 8 is a sectional view of another exemplary molded article according to an aspect of the present invention.

FIG. 9 is a sectional view of another exemplary molded article according to an aspect of the present invention.

FIG. 10 is a sectional view of a portion of another exemplary molded article according to an aspect of the present invention.

FIG. 11 is a sectional view of an example of formation of a molded article in accordance with an aspect of the present invention

FIG. 12 is a sectional view of yet another example of a portion of an article in accordance with an aspect of the present invention.

### DETAILED DESCRIPTION

The present invention is predicated upon the provision of molded parts having fabric surface areas and a process for the formation of such parts. Generally, a part formed according to the present invention will include a fabric surface piece overlaying a molded plastic substrate component. The present invention has been found particularly useful for forming parts that include a fabric surface piece overlaying a first surface and second surface of the molded plastic material wherein the fabric piece also extends and/or overlays an intermediate contour (e.g., a corner) that is adjacent the first and second surfaces. Typically the intermediate contour interconnects the first and second surfaces.

Generally, it is contemplated that the intermediate contour over which the fabric surface extends can be most any generally non-planar surface adjacent the first and second surface of the molded plastic material that can be overlayed by the fabric surface piece. Typically, the first surface is at an angle relative to the second surface of the molded plastic substrate component and such angle is typically less than about 140° more typically less than about 130° and still more typically less than about 120° and is typically greater than about 30°, more typically greater than about 45° and even more typically greater than about 60°. In particularly preferred embodiments, the first surface is at an angle relative to the second surface of less than 110°, more typically less than 95°, even more typically less than 90° and even possibly less than 80° or even 65°. It is also typical for the first and second surfaces to be relatively close to the intermediate contour, although not necessarily required. In a preferred embodiment, the first surface, the second surface or both are within 15 millimeters (mm), more typically within 10 millimeters (mm) and even more typically within 7 millimeters (mm) of a closest part of the intermediate contour.

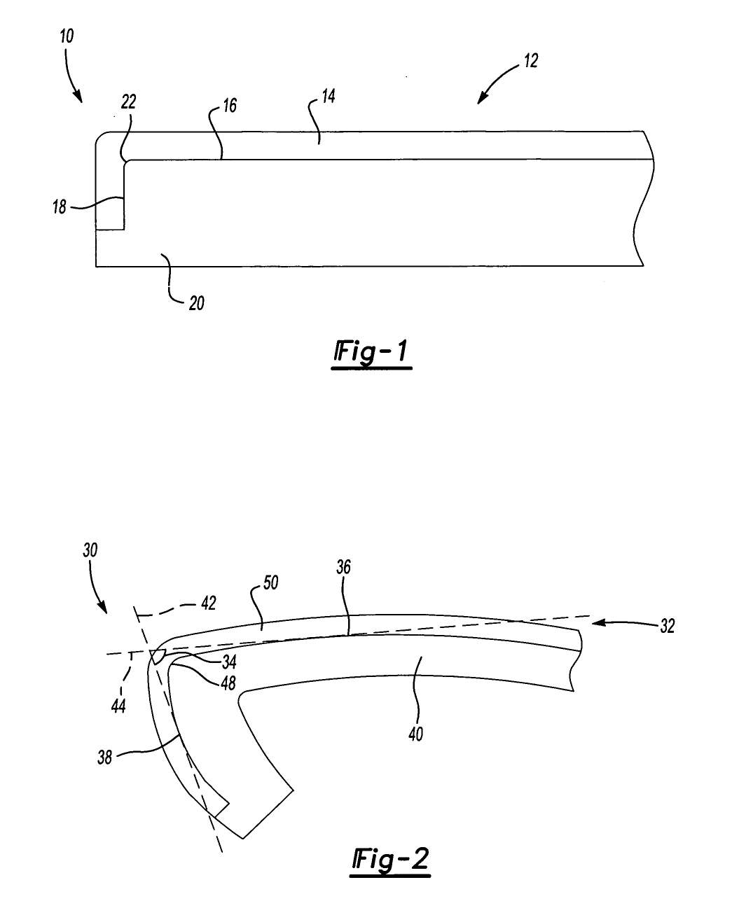

With reference to FIG. 1, an exemplary edge 10 of a part 12 is illustrated. As can be seen, a fabric surface piece 14 overlays a first surface 16 and a second surface 18 of a plastic substrate component 20 and the fabric surface piece 14 extends over a contour shown as a corner 22 of the substrate component 20. In the embodiment of FIG. 1, the first surface 16 and second surface 18 are substantially planar and are disposed at a 90° angle±about 10° relative to each other.

Of course, it is contemplated that the first and second surfaces of the molded plastic material need not necessarily be planar but could be arced, sloped or otherwise contoured. As an example, FIG. 2 illustrates an exemplary edge 30 of a part 32 that includes a first arced surface 36 and a second arced surface 38 of a plastic substrate component 40. As shown, the first arced surface 36 is dispose at an angle 34 (e.g., an acute angle of about 75°±10) relative to the second arced surface 38 as determined by dashed lines 42, 44 taken tangent to the surfaces 36, 38. Again, the plastic component 40 defines a corner 48 and a fabric piece 50 overlays the first surface 36, extends over the corner 48 and overlays the second surface 38.

Parts or articles according to the present invention can be formed according to a process of the present invention and the process can include a variety of different protocols or techniques within the main steps of the process. Generally, the process includes one or a combination of the following steps:
1) provision of a fabric piece;
2) location of the fabric piece adjacent a mold of a plastic molding machine; and
3) molding of a plastic material adjacent the fabric piece for forming a plastic substrate component with the fabric piece attached to the plastic component and preferably such that the fabric piece overlays a first and second surface of the plastic material and extends over or wraps about a contour of the plastic substrate component.

The plastic articles or parts according to the present invention can be prepared using multiple molding techniques. Exemplary molding techniques include, without limitation, blow molding, injection molding, compression molding or the like. According to one preferred technique, an adhered or laminated fabric surface piece is located between at least two mold parts or dies (usually referred to as a “core” and a “cavity”). The mold parts are brought together with the fabric piece therebetween such that a cavity is formed between the mold parts. A plastic material is then injected into the cavity such that the material hardens and forms into a plastic component substrate adhered to the fabric piece. The hardening of the plastic material can be brought about by cooling of the plastic material within the mold, by chemical reaction within the mold or both.

### Plastic Substrate Component with Adhered Fabric Piece

As mentioned above, this first or plastic substrate component can be prepared by generally known molding techniques that are suited to provide the necessary plastic substrate or base part having the fabric surface piece properly located and sufficiently adhered. A preferred molding technique is injection molding onto a pre-cut fabric piece that can be properly located and sufficiently fixed to an inner mold surface in an injection molding mold during the injection molding process. In the injection molding step molten plastic is injected into the mold, filling the mold, conforming the fabric piece to the mold shape and simultaneously laminating or bonding the fabric piece to the plastic. As will be discussed further below, the fabric piece can have a backing layer that facilitates the step or process of adhesion/lamination to the substrate component. Other suitable processes for forming the substrate and/or attaching the fabric include compression molding, radio frequency (RF) welding, sonic welding, thermoforming, injection compression molding, gas assist injection molding, structural foam injection molding, microcellular foam molding technology, laminar injection molding, water injection molding, external gas molding, shear controlled orientation molding, and gas counter pressure injection molding.

Thermosetting or thermosettable plastics can also be employed to similarly prepare the fabric-laminated plastic substrate component using techniques such as reaction injection molding or resin transfer molding.

The mold surface of any of the mold parts can be textured to any known surface finish that is desired for either the exposed portion of the fabric surface piece, the appearance or texture of the exposed portions of the plastic material or provide a desired surface for subsequently attaching or affixing either the fabric surface piece or other components thereto. Then, during the injection step the plastic enters the mold, filling the mold, conforming the fabric piece to the mold shape and imparting the mold surface/grain/texture onto the fabric or substrate material surface.

In general, the first or plastic substrate component can be prepared from a broad range of plastic materials including thermoset plastics such as polyurethane, epoxy or thermosetting silicone and thermoplastics such as polycarbonates (“PC”), ABS, polypropylene (“PP”), high impact polystyrene (“HIPS”), polyethylene (“PE”), polyester, polyacetyl, thermoplastic elastomers, thermoplastic polyurethanes (“TPU”), nylon, ionomer (e.g., Surlyn), polyvinyl chloride (“PVC”) and including blends of two or more of these thermoplastics such as PC and ABS. These materials may contain pigments, additives and/or fillers that contribute any needed cost and/or performance features such as surface appearance, ignition resistance, modulus, toughness, EMI shielding and the like. The plastic material of the molded plastic substrate component may be partially the same as, substantially exactly the same as or different than the material used in the backing of the fabric piece.

A wide range of fabric materials can be used for the fabric surface area of this invention. This is a tremendous advantage of the parts and process that are provided according to the present invention. The suitable fabric materials include but are not limited to: natural and synthetic leathers (including both leathers and suedes) and any types of textiles or textile-like materials such as, woven, non-woven, and knit fabrics from natural or synthetic fibers/materials including coagulated polyurethane laminates, PVC and other rigid or flexible film or sheet materials. The suitable “fabrics” may include laminates and structures combining two or more of the aforementioned materials. As one example of combined material, a fabric can include a material such a synthetic leather formed of a polymeric material (e.g., polyurethane) layered with a fibrous material such as a woven or unwoven fabric formed of polymeric (e.g., polyamide) or other strands or fibers. Although, the fabric may be partially or substantially rigid, it is typically preferable for the fabric to be “generally flexible” such that it does not typically return to a predetermined shape or configuration on its own after it is bent or otherwise deformed.

The fabric piece may also include one or more of the aforementioned materials with an adhered “backing material”. “Backing materials” are sometimes included on the fabrics that can be obtained and used or can be added if needed to adhere better to the substrate component, stiffen the fabric and/or prevent the molding plastic from being excessively forced into or through the back of the fabric. Backing materials can include a wide range of natural or synthetic materials or textiles including woven, non-woven, and knit fabrics from natural or synthetic fibers/materials; films, foams or sheets of a plastic (e.g., a thermoplastic) such as PC, PET, PBT, ABS, PA6,6, PP, HIPS, polystyrene (e.g., hydrogenated polystyrene) and blends of two or more of these materials. Although, the backing material may be partially or substantially flexible, it is typically preferable for the backing material to be “generally rigid” such that it can typically return to a predetermined shape or configuration on its own after it is bent or otherwise deformed in such a way that does not cause yielding of the backing material. Advantageously, lamination of the backing material to the fabric can often provide the fabric or overall laminate with a desired degree of rigidity. Moreover, the backing can provide rigidity to a normally elastic fabric thereby at least reducing the amount that such a fabric might stretch during molding of the substrate component. Thus, the present invention can be particularly advantageous for use with a fabric that would, without the backing material, otherwise exhibit stretching or movement (e.g., at a distal edge of the fabric) of greater than about 0.2 millimeters, more typically greater than about 0.5 millimeters, even more typically greater than about 1.0 millimeters and still more typically greater than about 3.0 millimeters during molding of the substrate component.

In one embodiment of the present invention, a foam layer can advantageously be included as a backing material for the fabric piece or an intermediate layer between the fabric surface piece and the substrate material. When using a compressible type of foam, this can provide or enhance the soft or cushioned feel of the fabric surface. This layer can be present on the fabric that is supplied for use or can be laminated to a fabric either prior to or during the molding/lamination of the substrate. In general, the foam can be open or closed cell and needs to be sufficiently heat resistant to retain its desired properties during the subsequent processing steps, for example not melting or collapsing to an unacceptable degree. Suitable foam densities are in the range of from about 5 to about 95 kilograms per cubic meter (kg/m³), preferably from about 20 to about 75 kg/m³, depending upon their layer thickness and degree of cushion or compression that is desired. The plastic material used in the foam can be a thermoset or thermoplastic and preferred foam plastic layers include a foamed thermoset polyurethane.

Bonding of the backing material to the fabric can be achieved by flame lamination, adhesive bonding, electromagnetic radiation bonding, or thermally initiated adhesive such as Dow Adhesive Film or other processes as will be recognized by the skilled artisan. Examples of desirable adhesives include epoxy, polyurethane, polyester or other adhesive materials. As may be needed for facilitating fabrication of the part design, the fabric surface piece with optional backing can be cut, stamped out, shaped, formed and/or preformed by techniques such as the known deep drawing processes for preparing pre-formed shapes to be inserted into the mold. Examples of preferred processes include, without limitation, high pressure forming, vacuum pressure forming, matched metal or mold die forming processes, high or low pressure bladder forming, hydroforming, plug assist forming, combinations thereof or the like. Depending upon the design of the finished article, there can be different fabric types used in different surface sections of the article.

In general, the combinations of fabric, the lamination of the fabric and the material of the plastic substrate component plastic are selected to obtain sufficient adhesion between them. The adhesion between the fabric surface piece and plastic substrate component is such that the fabric is not readily removed from the part during the subsequent processing, handling and or use of an article formed of the substrate component and fabric piece. It is also possible to apply an adhesive to a back side of the backing resulting in a more robust connection between the substrate component and the backing when the substrate component is molded to the back side of the backing.

It is also generally contemplated that an additional edge covering material or component may be molded upon the edges of the fabric piece. Such a material can be particularly advantageous for application to peripheral edges of the fabric piece and to more internal edges of the fabric piece formed by internal openings (e.g., through-holes and cavities) defined by the fabric piece. One example of such a material and its application can be found in U.S. Pat. No. 6,926,856, which is incorporated herein by reference in its entirety for all purposes.

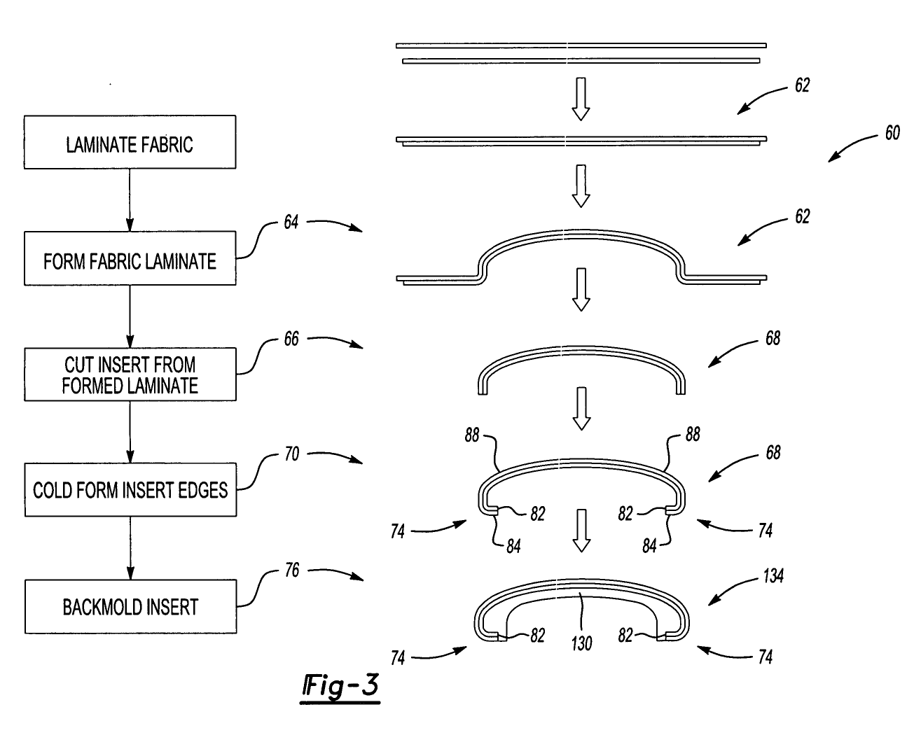

With reference to FIG. 3, a preferred exemplary process 60 is illustrated for forming a molded plastic article or part according to the present invention. As shown, a laminated fabric 62 is prepared according to one of the techniques discussed herein or otherwise. That fabric 62 is then shaped in a first forming step 64 to include one or more contours such as arcs, bends, curves, cavities or the like and cut 66 to a desired size and/or configuration thereby forming a fabric piece 68. Generally, the fabric may be cut and then shaped, shaped and then cut or these activities may take place partially or entirely simultaneously. In the particular embodiment illustrated, the fabric 62 is shaped to have a single arced central portion interconnecting body portions and/or intermediate contours of the part, which are discussed further below.

The fabric piece 68 is also typically formed or shaped in another forming step 70 to include one or more intermediate contours 74 (e.g., corners) and a plastic material is typically molded 76 to form a plastic substrate 130. As used herein, the intermediate contour of the fabric piece 68 can be any generally non-planar surface that is between a first portion and second portion of the fabric piece. Typically the intermediate contours of the fabric piece 68 are designed to correspond to intermediate contours of a plastic substrate as described above and further below. While it is contemplated that the intermediated contours of the fabric piece may be formed during forming of the fabric or during molding of the plastic material such contours are typically formed in a separate operation.

Typically, the first portion of the fabric piece is at an angle relative to the second portion of the fabric piece and such angle is typically less than about 140° more typically less than about 130° and still more typically less than about 120°and is typically greater than about 30°, more typically greater than about 45° and even more typically greater than about 60°. In particularly preferred embodiments, the first portion is at an angle relative to the second portion of less than 110°, more typically less than 95°, even more typically less than 90° and even possibly less than 80° or even 65°. It is also typical for the first and second portions to be relatively close to the intermediate contour, although not necessarily required. In a preferred embodiment, the first portion, the second portion or both are substantially entirely within 15 millimeters (mm), more typically within 10 millimeters (mm) and even more typically within 7 millimeters (mm) of a closest part of the intermediate contour.

In the embodiment depicted, the fabric 62 is shaped in the first forming step 64 and then cut. It is contemplated that shaping of the fabric 62 may be accomplished according to several techniques. Shaping may be part of the lamination process. Shaping might also be accomplished by physical deformation (e.g., bending) of the laminate fabric 62, for example at elevated temperatures. In a preferred embodiment, a forming die is employed to shape the fabric at an elevated temperature. For example, the fabric 62 can be located between a first die corresponding to a second die and the fabric can be sandwiched between the dies at an elevated temperature for a predetermined period of time such that the fabric assumes a shape corresponding to the dies. Shaping of the fabric can be accomplished by exposing the fabric to an environment (e.g., an oven) having a temperature of at least 200° C. for a period of at least 4 seconds, more typically at least 280° C. for at least 10 seconds and even more typically a temperature of at least 365° for at least 16 seconds but also typically less than 500° C. and less than 60 seconds, more typically less than 450° C. and less than 40 seconds and even more typically less than 420° C. and less than 30 seconds although higher or lower temperature and time periods may be used. Advantageously, multiple sections of a single laminate fabric can be formed at substantially the same time with each of the sections corresponding to a fabric piece for a different part.

The intermediate contours 74 of the fabric piece 68 can be formed using multiple techniques. As an example, a forming tool may be employed to cold form or heat form the intermediate contours 74. It is also contemplated that a die (which may be heated and which may include moveable components) also may be employed for forming the contours 74. Such formation could be accomplished using the dies discussed during the first forming step 64 or with one or more secondary dies.

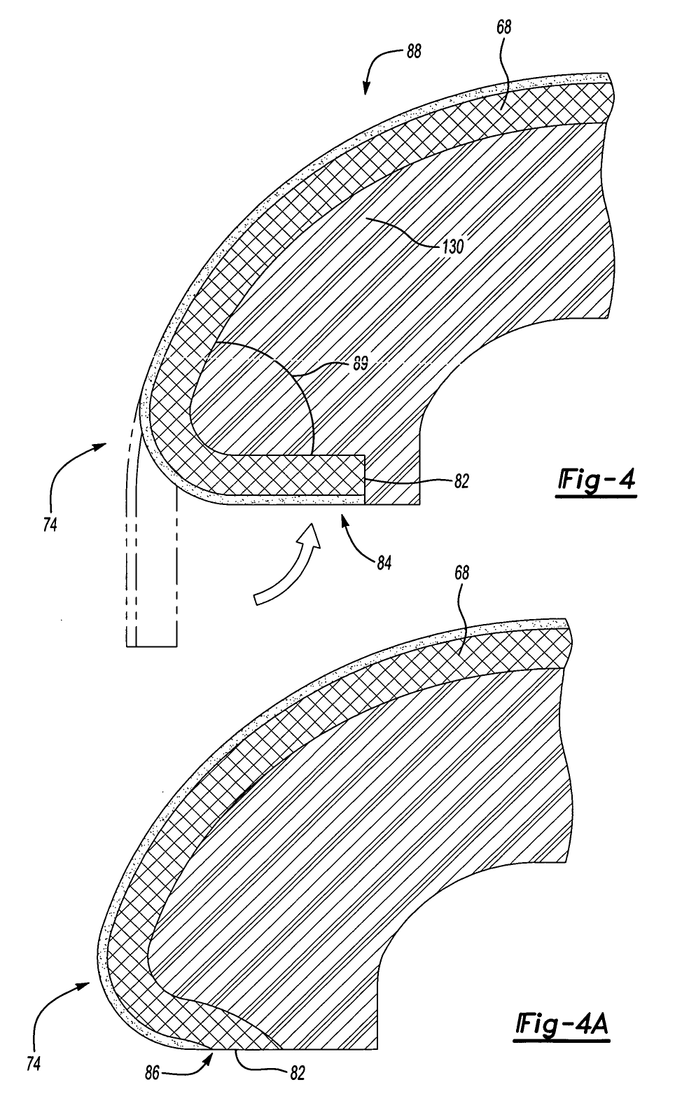

In the embodiment shown in FIGS. 3 and 4, a tool or other device is employed to form the intermediate contours 74 adjacent distal edges 82 of the fabric piece 68 and also form flanges 84 such that the intermediate contour 74 interconnects a first portion shown as a body portion 88 of the fabric piece 68 with a second portion shown as the flange 84 of the fabric piece 68. As shown, the first portion 88 is at an angle 89 of about 75°±10 with the second portion 84. A suitable tool for forming the contour 74 might be a cold forming tool, which may be heated or unheated, that includes a blade that bends the flange 84 of the fabric piece 68 about another member and typically applies a force or stress sufficient to yield the backing material such that the contour remains after bending. It is also contemplated that the contours 74 might be formed by heating the fabric piece and bending the flanges 84 over followed by cooling of the piece. During such an operation, it is contemplated within the scope of the present invention that, as shown in FIG. 4A, the distal edge 82 of the fabric piece 68 during formation of the contour 74 may become part of an outer surface 86 of the fabric piece or article due to stresses or strains placed upon the piece 68.

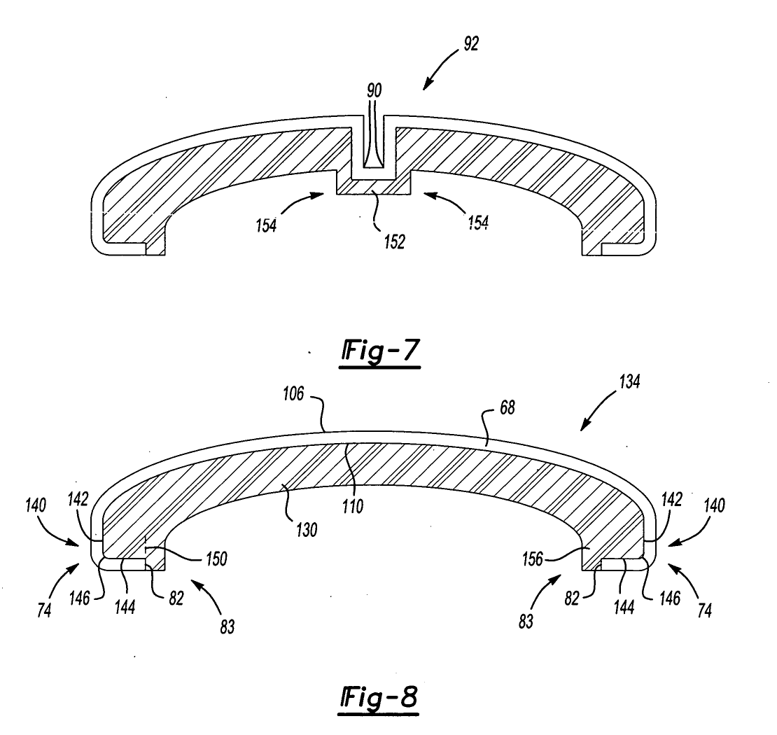

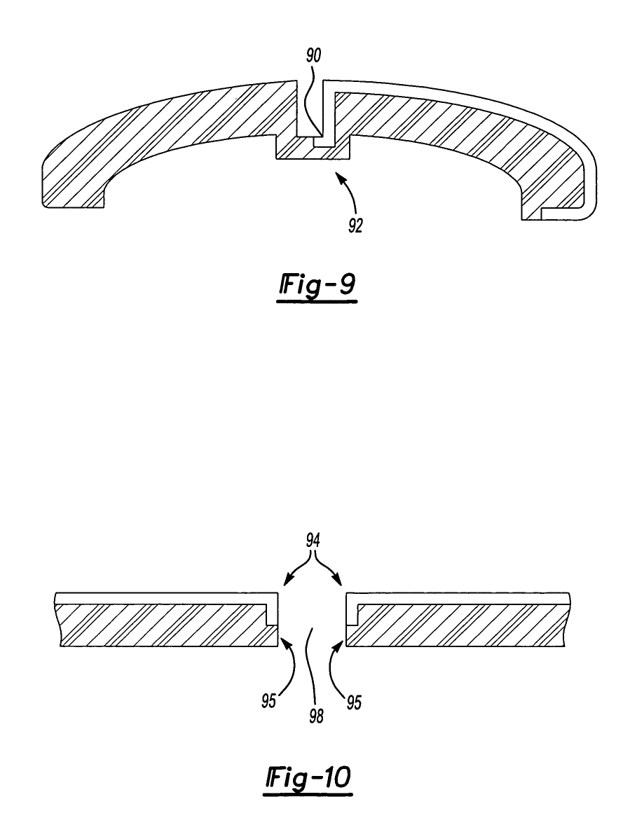

While the intermediate contours 74 are illustrated as being formed adjacent (e.g., within 10, 5, or 2 millimeters of) the distal edges 82 of the fabric piece 68, it is additionally contemplated that, as shown in FIGS. 7 and 9, such contours 90 could also be formed at internal areas or edges 92 (e.g., areas greater than 5 mm from a distal edge) of the fabric piece and that the fabrics at those areas might stop at the internal areas or continue therethrough.

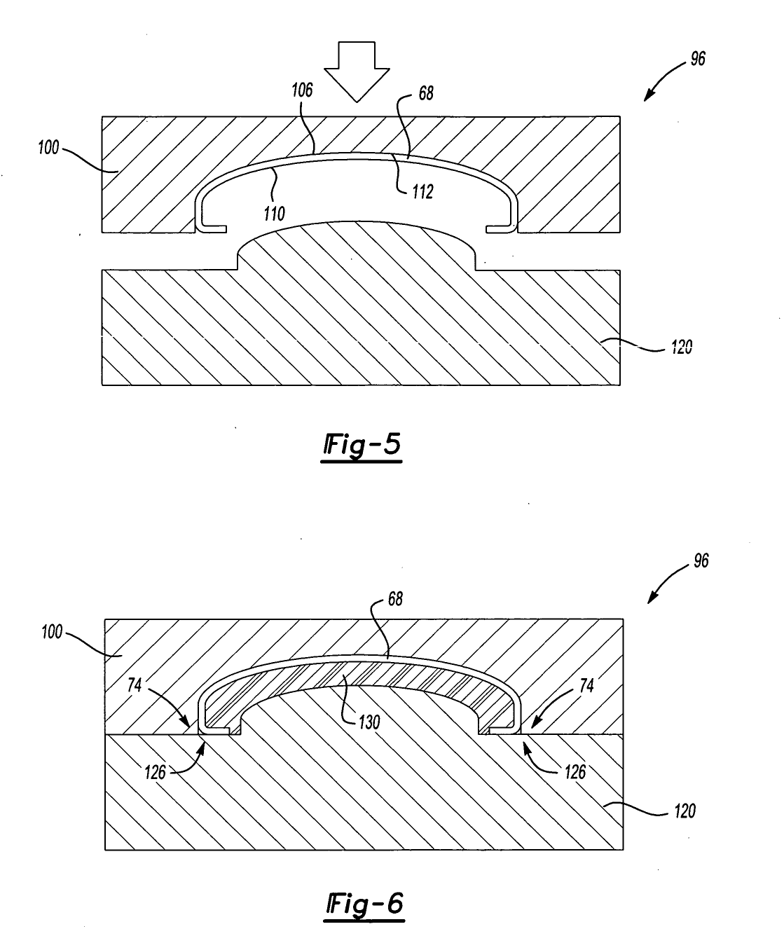

Referring to FIG. 5, the fabric piece 68 is typically placed within a mold 96 of a molding machine (e.g., an injection, compression or other molding machine). In the illustrated embodiment, the fabric piece 68 is located adjacent or within a first die 100 of the mold 96 and held in place in the die such that a first surface 106 of the fabric piece 68 facing out of the die 100 and a second surface 110 of the fabric piece 68 facing and opposing a surface 112 of the die 100. The fabric piece 68 can be held in place relative to the mold 96, for example, by vacuum pressure, mechanical features of the mold 96, nesting of the fabric piece with the mold, combinations thereof or the like.

The mold 96 is then closed as shown in FIG. 6 (e.g., by moving the first die 100 and second die 120 together or toward each other) and the plastic material is fed (e.g., injected) into an opening within the mold 96. The conditions at which the plastic material is fed into the mold can vary depending upon the plastic material, the backing of the fabric piece and other factors. Generally, it has been found that temperatures between about 200° C. and about 450° C. and pressures (e.g., cavity pressures) between about 500 psi and about 40,000 psi are suitable for many applications although higher or lower temperatures and/or pressure may be employed.

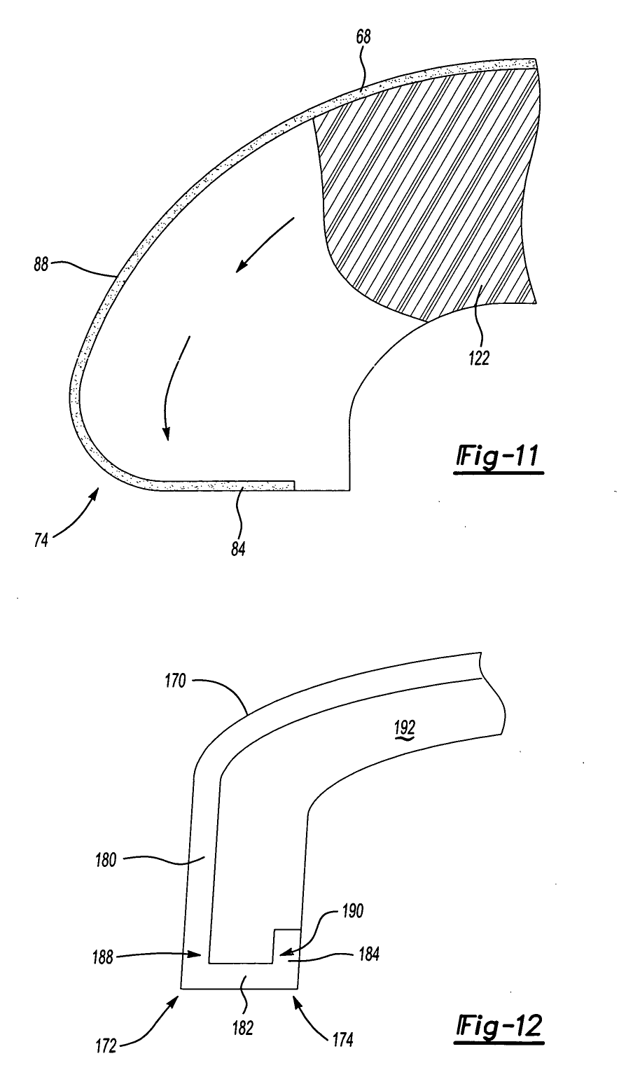

As shown, in FIG. 11, it is generally preferable that the plastic material 122, as it is fed to the mold 96, travel toward and/or along portions 84, 88 of a fabric piece 68 that form an interconnecting contour 74, although not required. In such an embodiment, the plastic material 122 will typically travel in a direction substantially parallel to the first portion 88 and substantially perpendicular and/or toward the second portion 84.

Referring back to the particular embodiment of FIGS. 5 and 6, each intermediate contour 74 of the fabric piece 68 nests within an angled portion 126 of the mold prior to feeding of the plastic material into the mold. As shown, the angled portion 126 has a size and shape corresponding to the intermediate contour 74 of the fabric piece 68. While each intermediate contour 74 of the fabric piece 68 is shown to nest with its angled portion 126 of the mold 96 after closure of the mold, it is contemplated that the mold, or dies thereof, may be shaped such that each contour 74 nests with its angled portion 126 prior to closing of the mold 96.

Once fed (e.g., injected) into the opening of the mold 96, the plastic material forms a plastic substrate component 130 that is adhered to substantially the entire back surface 110 of the fabric piece 68 thereby forming a molded plastic article 134 having the fabric 68 as at least one surface of the article 130. Preferably, the material does not flow onto the front surface 106 of the fabric leaving substantially the entirety of the front surface 106 of the fabric uncovered.

Once molding is completed, the molded plastic article 134 can be removed from the mold 96 as shown in FIG. 8. In the embodiment shown the plastic substrate component 130 includes one or more (e.g., two) edges that are at least partially defined by a first surface 142 and a second surface 144 interconnected by an intermediate contour 146 (e.g., corner) of the plastic substrate component. The fabric piece 68 overlays the first surfaces 142 and second surfaces 144 of the plastic substrate component 130 and the fabric piece 68 extends over the intermediate contour 146 of the plastic substrate component 130 such that the intermediate contour 74 of the fabric piece 68 overlays the intermediate contour 146 of the plastic substrate component 130.

In exemplary embodiment, the intermediate contours 74, 146 are illustrated as being formed adjacent (e.g., within 10, 5, or 2 millimeters of) the distal edges 82, 83 of the fabric piece 68 and/or the substrate component 130. Thus, the distal edges of the fabric may be at or adjacent (e.g., within 10, 5, or 2 millimeters of) the distal edges of the substrate component or the distal edges of the fabric may be non-adjacent (e.g., greater than 5, 10 or more millimeters of) the distal edges of the substrate component. It is also contemplated that, as shown in FIG. 10, edges 94, 95 of the fabric piece 68 or substrate component 130 may be formed by cavities or openings (e.g., a through-hole 98) of a part.

Advantageously, using the fabric pieces as defined herein, one or more portions of the fabric piece, during molding of the article, can be positively located within 1.0 mm, more typically within 0.5 mm and even more typically within 0.2 mm of a predetermined location upon the second surface of the plastic substrate component. In the particular embodiment shown, each distal edge 82 of the fabric piece 68 is positively located within 0.2 mm of a location 150 within and/or along the thickness and/or the second surface of the plastic substrate component 130. The particular location 150 illustrated is a distance (D) of 2 mm from the intermediate contour 146 of the plastic substrate component 130, however, the location may, of course, be different as desired for any particular part or article. For example, in FIG. 7, the particular location could be a midpoint 152 between intermediate contours 90, 154 of a fabric piece and/or a plastic substrate component.

Typically, the thickness of the substrate component extends between an outer surface (e.g., the first surface 142) and an inner surface 155 of the substrate component. Generally, it is contemplated that the distal edge 82 of the fabric piece 68 may be substantially coincident with the inner surface 155, it is preferable that the distal edge be along the thickness and between the inner surface 155 and outer surface 142 (e.g., at least 0.2, 0.5, 1.0 or more millimeters away from the inner and outer surfaces).

It is also contemplated that a fabric piece according to the present invention can include multiple intermediate contours for extending over multiple intermediate contours of a substrate components. With reference to FIG. 12, a fabric piece 170 is shown to include a first intermediate contour 172 and a second intermediate contour 174 interconnecting multiple portions 180, 182, 184 of the fabric piece 170 and extending over first and second intermediate contours 188, 190 of the substrate component 192.

As an additional advantage, the process, materials, components or a combination thereof, while useful for fabrics and substrates of almost any thickness, can be particularly effective for placements of fabrics upon molded plastic substrate components where the fabric pieces, the substrate components or both are relatively thin. For thinner articles, the thickness of substantially the entirety of the backing is typically less than about 3 millimeters (mm), more typically less than about 1 millimeter (mm), even more typically less than about 0.5 millimeters (mm) and still more typically less than about 0.2 millimeters (mm). The thickness of substantially the entirety of the plastic substrate component is typically less than about 5 millimeters (mm), more typically less than about 3 millimeters (mm) and even more typically less than about 1.5 millimeters (mm). The thickness of substantially the entirety of the fabric piece is typically less than about 5 millimeters (mm), more typically less than about 2 millimeters (mm) and even more typically less than about 1 millimeter (mm). As such, the overall thickness of substantially the entirety of the article including the plastic substrate component and the fabric piece is typically less than about 10 millimeters (mm), more typically less than about 5 millimeters (mm) and even more typically less than about 2.5 millimeters (mm).

It is generally contemplated that the articles, including the fabric piece, substrate component or both, of the present invention can serve as a member (e.g., panel, portion, flap, closure panel or the like) of several different products. Preferably, the articles have at least one surface, particularly the fabric surface, facing outwardly from whatever end product the articles are part of and providing a desirable aesthetic appearance to the article. The articles of the present invention may be used in various end products. For example the articles can be used for consumer electronics such as cell phones; PDAs; notebook and desktop computers; headsets; audio equipment such as disc players, MP3 players; video equipment such as televisions and remote DVD players or other types of consumer electronics. In one preferred embodiment, an article of the present invention is used in a wireless headset or earpiece for a phone (e.g., for Bluetooth® wireless technology). The articles may also be used in premium packaging such as packaging for cosmetics, disc storage units or the like. It is also contemplated that the articles may be used for appliances or household goods such as laundry machines, lamps, furniture, refrigerators or the like. Moreover, the substrate components can be employed in automotive applications such as for door panels, trim panels, instrument panels, automotive consoles, headliners, close-out panels, visors, combinations thereof or the like.

### EXAMPLE

A part according to the present investigation as shown in FIG. 8 can be designed and produced generally as shown in FIGS. 1 through 6 and discussed above. The fabric can be stretchable synthetic leather comprised of a coagulated polyurethane top coat bonded to a woven polyamide backcloth, the fabric layers having a combined thickness of approximately 0.6 mm. A 0.007 inch thick PC/PET film backing is laminated to the backcloth side of the fabric with a 0.001 inch thermally activated copolyester adhesive film in a flat bed laminator at a temperature of 240 F, a dwell time of 30 seconds, and pressure of 10 lb per lineal inch of width. The resulting fabric laminate is cut into rectangular blanks which are held in a clamping mechanism and inserted in a heating chamber of a forming machine at a temperature of 390 C for 25 seconds and are formed with a tool such that the fabric laminate retains the shape of the forming tool. The formed fabric laminate is then placed in a nest of a 3D cutter having multiple blades which are machined to the contour of the formed shape and a formed fabric piece is cut from the laminate. The edge of the fabric piece is cut to be 1 mm longer than the edge of a corresponding cavity of an injection mold. Prior to placing the fabric piece in the mold cavity for subsequent backmolding, the fabric piece is nested in a secondary tool that bends the 1 mm of excess length of insert edge at a 90 degree angle creating a flange at the perimeter of the fabric piece. This flanged-edge fabric piece is then placed in the cavity side of an injection molding tool. A corresponding core side of an injection molding tool is brought into contact with the cavity side such that a hollow channel of 1.5 mm thickness and having the shape of the desired part is created for molding a part. The two mold halves are clamped together and molten PC at a temperature of 310 C is injected through an opening in the core side of the injection molding tool. The molten PC flows against the backing side of the formed fabric piece pushing the fabric piece against the cavity side of the injection mold tool, filling the space in the injection molding tool such that a fabric surface of the fabric piece covers the appearance or show side of the part as well as the edges of the part. The molten PC cools in the injection mold tool, the mold halves are unclamped and separated and the part is removed. The part so produced has improved appearance and durability at its edges owing to the process which brings the fabric surface around the edge of the part.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A process of forming a molded plastic article, comprising:
providing a surface fabric piece, wherein:
i. the fabric piece is comprised of a fabric and a backing, the backing having a thickness of less than about 0.5 millimeters;
ii. the fabric piece has a predetermined shape that includes a first portion disposed at an angle relative to a second portion, the first portion interconnected with the second portion by an intermediate contour;
locating the fabric piece between portions of a mold, wherein:
i. the intermediate contour of the fabric piece, before or after closure of the mold, nests within an angled portion of the mold, the angled portion having a size and shape corresponding to the intermediate contour of the fabric;
molding a plastic material to form a plastic substrate component adhered to the fabric piece thereby forming the molded plastic article, wherein:
i. the plastic substrate component includes a first surface and a second surface interconnected by an intermediate contour of the plastic substrate component;
ii. the fabric piece overlays the first surface and second surface of the plastic substrate component and the fabric piece extends over the intermediate contour of the plastic substrate component such that the intermediate contour of the fabric piece overlays the intermediate contour of the plastic substrate component;
removing the molded plastic article from the molding machine.

2. A process as in claim 1 wherein molding of the plastic material includes injecting the plastic material into a mold such that the material travels substantially parallel to the first portion of the fabric piece and travels perpendicular to and toward the second portion of the fabric piece.

3. A process as in claim 1 wherein the fabric is a synthetic leather or suede layered with a woven polymeric material.

4. A process as in claim 1 wherein the second portion is connected to a central portion having an arced shape.

5. A process as in claim 1 wherein the angle of the first portion of the fabric piece relative to the second portion of the fabric piece is less than about 95°.

6. A process as in claim 1 wherein the substrate component has a thickness between the first surface of the substrate component and an inner surface of the substrate component and a distal edge of the fabric piece is located between the first surface and inner surface along the thickness.

7. A process as in claim 6 wherein the angle of the first surface of the molded plastic substrate component relative to the second surface of the molded plastic substrate component is less than about 95°.

8. A process as in claim 1 wherein the first portion of the fabric piece is disposed at an angle relative to the second portion of the fabric piece and the angle is less than about 90°.

9. A process as in claim 6 wherein the angle of the first surface of the molded plastic substrate component relative to the second surface of the molded plastic substrate component is less than about 90°.

10. A process of forming a molded plastic article, comprising:
providing a surface fabric piece, wherein:
i. the fabric piece is comprised of a fabric and a thermoplastic backing;
ii. the fabric piece has a predetermined shape that includes a first portion disposed at an angle relative to a second portion, the first portion interconnected with the second portion by an intermediate contour, the angle being less than 110°;
iii. the intermediate contour is a corner or bent portion of the fabric piece and is within 5 mm of a distal edge of the fabric piece;
iv. provision of the surface fabric piece includes lamination of the fabric to the thermoplastic backing; and
v. substantially the entirety of the fabric piece has a thickness no greater than 2 mm;
locating the fabric piece between portions of a mold of an injection molding machine and closing the mold, wherein:
i. the intermediate contour of the fabric piece, before or after closure of the mold, nests within an angled portion of the mold, the angle portion having a size and shape corresponding to the intermediate contour of the fabric;
ii. the fabric piece is held in place within the mold by vacuum pressure or mechanical features of the mold;
molding, via injection molding, a plastic material to form a plastic substrate component adhered to substantially an entire back surface of the fabric piece while leaving substantially an entire front surface of the fabric uncovered thereby forming the molded plastic article, wherein:
i. the plastic substrate component includes a distal edge that is at least partially defined by a first surface and a second surface interconnected by an intermediate contour of the plastic substrate component;
ii. the fabric piece overlays the first surface and second surface of the plastic substrate component and the fabric piece extends over the intermediate contour of the plastic substrate component such that the intermediate contour of the fabric piece overlays the intermediate contour of the plastic substrate component;
iii. a portion of the fabric piece, during the molding, is positively located within 0.5 mm of a predetermined location upon the second surface of the plastic substrate;
iii. the portion of the fabric piece is a distal edge of the fabric piece; and
iv. substantially the entirety of the plastic substrate component has a thickness less than about 4 mm;
v. a distal edge of the fabric piece is adjacent the distal edge of the substrate component;
removing the molded plastic article from the molding machine.

11. A process as in claim 10 wherein molding of the plastic material includes injecting the plastic material into a mold such that the material travels substantially parallel to the first portion of the fabric piece and travels perpendicular to and toward the second portion of the fabric piece.

12. A process as in claim 10 wherein the fabric is a synthetic leather or suede layered with a woven polymeric material.

13. A process as in claim 10 wherein the angle of the first portion of the fabric piece relative to the second portion of the fabric piece is less than about 95°.

14. A process as in claim 10 wherein the angle of the first surface of the substrate component relative to the second surface of the substrate component is less than about 95°

15. A process as in claim 10 wherein the angle of the first portion of the fabric piece relative to the second portion of the fabric piece is less than about 75°.

16. A process as in claim 10 wherein the angle of the first surface of the substrate component relative to the second surface of the substrate component is less than about 75°.

17. A process as in claim 10 wherein the fabric is generally flexible and the backing is generally rigid.

18. A process of forming a molded plastic article, comprising:
providing a surface fabric piece, wherein:
i. the fabric piece is comprised of an aesthetically desirable fabric, a covering material and a thermoplastic backing;
ii. the fabric piece has a predetermined shape that includes a first portion disposed at an angle relative to a second portion, the first portion interconnected with the second portion by an intermediate contour, the angle;
iii. the intermediate contour is a corner or bent portion of the fabric piece and is within 5 mm of a perimeter edge of the fabric piece;
iv. the thermoplastic backing is a solid film includes a mixture of polycarbonate and polyethylene terephthalate;
v. the aesthetically desirable fabric is selected from leather, woven material, fibrous material, polymeric material or combinations thereof;
vi. provision of the surface fabric piece includes lamination of the fabric to the thermoplastic backing; and
vii. substantially the entirety of the fabric piece has a thickness no greater than 2 mm;
locating the fabric piece within a mold of an injection molding machine and closing the mold, wherein:
i. the intermediate contour of the fabric piece, before or after closure of the mold, nests within an angled portion of the mold, the angle portion having a size and shape corresponding to the intermediate contour of the fabric;
ii. the fabric piece is held in place within the mold by vacuum pressure or mechanical features of the mold or nestin;
molding, via injection molding, a plastic material to form a plastic substrate component adhered to substantially an entire back surface of the fabric piece while leaving substantially an entire front surface of the fabric uncovered thereby forming the molded plastic article, wherein:
i. the plastic substrate component includes an edge that is at least partially defined by a first surface and a second surface interconnected by an intermediate contour of the plastic substrate component;
ii. the fabric piece overlays the first surface and second surface of the plastic substrate component and the fabric piece extends over the intermediate contour of the plastic substrate component such that the intermediate contour of the fabric piece overlays the intermediate contour of the plastic substrate component;
iii. a portion of the fabric piece, during the molding, is positively located within 0.5 mm of a predetermined location upon the second surface of the plastic substrate;
iv. the portion of the fabric piece is a distal edge of the fabric piece; and
v. substantially the entirety of the plastic substrate component has a thickness less than about 4 mm;
removing the molded plastic article from the molding machine.

19. A process as in claim 18 wherein the angle of the first surface of the substrate component relative to the second surface of the substrate component is less than about 75°.

20. A process as in claim 18 wherein the fabric is generally flexible and the backing is generally rigid.
